(19) United States
(12) Patent Application Publication
(10) Pub. No.: US 2016/0248519 A1
(43) Pub. Date: Aug. 25, 2016

(54) VARIABLE POWER SPLITTER FOR EQUALIZING OUTPUT POWER

(71) Applicant: Coriant Advanced Technology, LLC, New York, NY (US)

(72) Inventors: Ari Novack, New York, NY (US); Matthew Akio Streshinsky, New York, NY (US); Yangjin MA, New York, NY (US); Michael J. Hochberg, New York, NY (US)

(21) Appl. No.: 14/963,205

(22) Filed: Dec. 8, 2015

Related U.S. Application Data
(60) Provisional application No. 62/118,420, filed on Feb. 19, 2015.
(60) Provisional application No. 62/132,742, filed on Mar. 13, 2015.

(51) Int. Cl. H04B 10/564; G02B 6/27

(52) U.S. Cl. CPC H04B 10/564; G02B 6/2793

(57) ABSTRACT

A variable power splitter apparatus and methods of using the same. In some cases, polarization dependent losses in a polarization-multiplexed system are minimized. In the systems and methods described here, in various configurations, the variable power splitter is either tunable or calibrated such that the difference in power between two optical loads is controlled to provide equal power after the respective light components traverse the respective optical loads. The result is that the average power is used. In one example, if the variable power splitter is tuned to balance the polarization dependent losses which occur in a 2:1 ratio, it would have a coupling ratio of 66/33, with the higher power going into the arm with twice the loss. The power in each path is then equal with a loss of 1.8 dB instead of 3 dB.

### CROSS-REFERENCE TO RELATED APPLICATIONS

This application claims priority to and the benefit of co-pending U.S. provisional patent application Ser. No. 62/118,420 filed Feb. 19, 2015, and co-pending U.S. provisional patent application Ser. No. 62/132,742 filed Mar. 13, 2015, each of which applications is incorporated herein by reference in its entirety.

### FIELD OF THE INVENTION

The invention relates to devices for coupling optical communication components in general and particularly to an optical coupler that handles optical signals having different polarizations.

### BACKGROUND OF THE INVENTION

Often, a single optical source will provide optical power to multiple circuits. For example, a polarization-multiplexed transmitter could use a single laser source for the modulators of both polarizations. The simple way to do this would be to split the light in half and send one half to each modulator, then combine at the output. However, there is often a polarization dependent loss (PDL) involved in the circuit such that one polarization will experience more loss than the other. Typically, a variable optical attenuator (VOA) is used to reduce the power on one of the polarizations until the two polarizations are balance. However, this unnecessarily throws away optical power.

There is a need for improved power equalization circuits that handle multiple polarizations without excessive losses.

### SUMMARY OF THE INVENTION

According to one aspect, the invention features an apparatus. The apparatus, comprises a variable optical power splitter configured to split an optical input signal having a power P into at least two power components having respective powers represented by a ratio P1:P2, the variable optical power splitter having at least one optical input port configured to receive the optical input signal, and at least one optical output port configured to provide a respective optical output signal; and a respective optical load in optical communication with a selected one of the at least one optical output port; the apparatus configured to compensate for a variation in power that is observable after the optical output signal traverses the respective optical load, the variation in power caused by variations in the optical load.

In one embodiment, the apparatus comprises a multiplexer having N inputs and M outputs, where N and M are integers, at least one of N and M being greater than one.

In another embodiment, the variable optical power splitter is configured to provide multiple signals as output.

In yet another embodiment, the multiple signals as output comprise multiple polarizations.

In a further embodiment, the multiple signals as output comprise multiple wavelengths.

In still another embodiment, the variable optical splitter is configured to provide multiple polarizations as output in a single signal.

In yet a further embodiment, the variable optical splitter is configured to provide multiple wavelengths as output in a single signal.

In an additional embodiment, the optical load is configured to exhibit a loss that depends on an optical path.

In one more embodiment, the optical load is configured to exhibit a loss that depends on an optical signal characteristic.

In still a further embodiment, the apparatus further comprises a feedback loop comprising a sensor configured to measure at least one power that is observable after a first one of the respective optical output signal traverses the respective optical load and to provide a measurement signal, and a controller configured to receive the measurement signal, configured to compare the measurement signal to another value, and configured to control the ratio P1:P2 by way of at least one control signal input port of the optical power splitter.

In one embodiment, the another value is a measured value of a power that is observable after a different respective optical output signal traverses its respective optical load.

In another embodiment, the another value is a stored value.

According to another aspect, the invention relates to a method of manipulating an optical signal. The method comprises the steps of: providing an apparatus comprising: a variable optical power splitter configured to split an optical input signal having a power P into at least two power components having respective powers represented by a ratio P1:P2, the variable optical power splitter having at least one optical input port configured to receive the optical input signal, and at least one optical output port configured to provide a respective optical output signal; and a respective optical load in optical communication with a selected one of the at least one optical output port; the apparatus configured to compensate for a variation in power that is observable after the optical output signal traverses the respective optical load, the variation in power caused by variations in the optical load; splitting an optical signal having an input power P into at least two power components having respective powers represented by a ratio P1:P2; measuring a residual power Pr1 in the first of the at least two power components after the first power component has traversed a respective optical load; and adjusting the ratio of P1:P2 based on the measured value of Pr1 and another value.

In one embodiment, the apparatus further comprises a feedback loop comprising a sensor configured to measure at least one power that is observable after a first one of the respective optical output signal traverses the respective optical load and to provide a measurement signal, and a controller configured to receive the measurement signal, configured to compare the measurement signal to another value, and configured to control the ratio P1:P2 by way of at least one control signal input port of the optical power splitter.

In another embodiment, the another value is a measured value of a power that is observable after a different respective optical output signal traverses its respective optical load.

In yet another embodiment, the another value is a stored value.

In still another embodiment, the optical load is configured to exhibit a loss that depends on an optical path.

In a further embodiment, the optical load is configured to exhibit a loss that depends on an optical signal characteristic.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic diagram of a fixed power splitter constructed using a fixed directional coupler.

FIG. 2 is a schematic of a photonic circuit that includes a tunable power splitter with an output to N separate circuits constructed according to the principles of the invention.

FIG. 3 is a schematic of a photonic circuit that includes a tunable power splitter with an output to N separate circuits and an N to M multiplexer constructed according to the principles of the invention.

FIG. 4. is a schematic diagram of a photonic circuit including a tunable power splitter, two separate circuits and a polarization rotator combiner, constructed according to the principles of the invention. The polarization at different locations in the photonics circuit are labeled.

FIG. 5 is a schematic of a photonic circuit that includes two tunable power splitters with an output to N separate circuits and an N to M multiplexer constructed according to the principles of the invention.

FIG. 6 is a schematic of one implementation of a 1×2 tunable power splitter constructed according to the principles of the invention.

FIG. 7 is a schematic of one implementation of a 1×4 tunable power splitter constructed according to the principles of the invention.

FIG. 8 is a flow diagram that illustrates a method of manipulating an optical signal.

### DETAILED DESCRIPTION

### Acronyms

A list of acronyms and their usual meanings in the present document (unless otherwise explicitly stated to denote a different thing) are presented below.

AMR Adabatic Micro-Ring

APD Avalanche Photodetector

ARM Anti-Reflection Microstructure
ASE Amplified Spontaneous Emission
BER Bit Error Rate
BOX Buried Oxide
CMOS Complementary Metal-Oxide-Semiconductor
CMP Chemical-Mechanical Planarization
DBR Distributed Bragg Reflector
DC (optics) Directional Coupler
DC (electronics) Direct Current
DCA Digital Communication Analyzer
DRC Design Rule Checking
DUT Device Under Test
ECL External Cavity Laser
FDTD Finite Difference Time Domain
FOM Figure of Merit
FSR Free Spectral Range
FWHM Full Width at Half Maximum
GaAs Gallium Arsenide
InP Indium Phosphide
LiNO₃ Lithium Niobate
LIV Light intensity(L)-Current(I)-Voltage(V)
MFD Mode Field Diameter
MPW Multi Project Wafer
NRZ Non-Return to Zero
PIC Photonic Integrated Circuits
PRBS Pseudo Random Bit Sequence
PDFA Praseodymium-Doped-Fiber-Amplifier
PDL Polarization Dependent Loss
PSO Particle Swarm Optimization
Q Quality factor

$$Q = 2 π \times \frac{Energy Stored}{Energy dissipated per cycle} = 2 π {f}_{r} \times \frac{Energy Stored}{Power Loss} ,$$

QD Quantum Dot
RSOA Reflective Semiconductor Optical Amplifier
SOI Silicon on Insulator
SEM Scanning Electron Microscope
SMSR Single-Mode Suppression Ratio
TEC Thermal Electric Cooler
VOA Variable Optical Amplifier
WDM Wavelength Division Multiplexing

In the prior art, it is conventional to use a 50/50 coupler. In the prior art it is common to use a VOA and to reduce the output power of each arm to the minimum of the two. For example, in a circuit with 3 dB polarization dependent loss after the directional coupler, the conventional prior art VOA approach would result in a total loss of 3 dB in each arm.

Described are apparatus and methods that minimize polarization dependent losses in a polarization-multiplexed system. In the systems and methods described here, in various embodiments, the directional coupler is either tunable or calibrated such that the difference in power between the two polarization arms cancels out the polarization dependent loss. The result is that the average power is used.

In one embodiment, the directional coupler is tuned to balance the PDL, it would have a coupling ratio of 66/33, with the higher power going into the arm with twice the loss. The power in each path is then equal with a loss of 1.8 dB instead of 3 dB.

In addition, in various embodiments, the complexity of the circuit may also be reduced as only one variable directional coupler is needed as compared to two VOAs as implemented in the prior art.

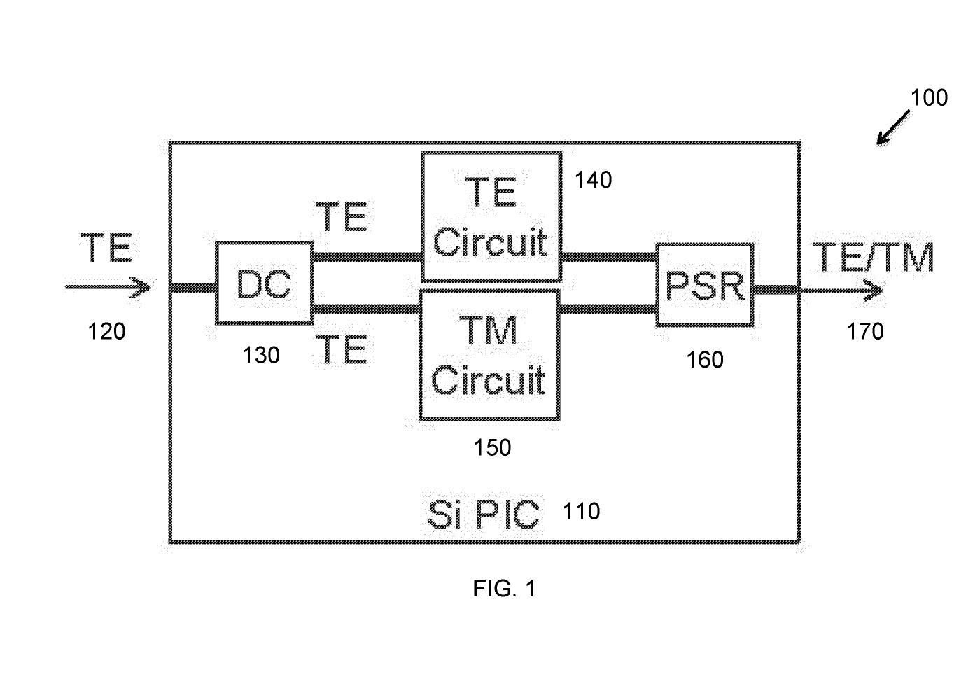

FIG. 1 is a schematic diagram 100 of a fixed power splitter constructed using a fixed directional coupler.

As illustrated in the embodiment shown in FIG. 1, a silicon photonic integrated circuit 110 has an optical input port 120 and an optical output port 170. The optical input port 120 receives optical signals, such as a TE mode optical signal provided by a source. The source can be an optical fiber, a signal generator such as a carrier signal source in conjunction with a modulator, or any other conventional optical signal source. The received signal is split in a fixed signal splitter 130 (illustrated as a fixed directional coupler DC) into a plurality of signals each characterized by a mode, which are illustrated as two TE modes. One mode is then manipulated by a first optical manipulation circuit 140 (illustrated as a TE mode circuit) to produce a first modified signal and the other mode is then manipulated by a second optical manipulation circuit 150 (illustrated as a TM mode circuit) to produce a second modified signal. The two modified signals are then combined using a combiner circuit 160 (illustrated as a polarization rotator and splitter, PSR) which provides an output signal. In the embodiment illustrated in FIG. 1, the polarization of the optical signal is maintained in both optical paths until the PSR generates a second polarization. Because the polarizations from the input port to the PSR are equivalent, there is no polarization dependent loss in in one path over the other path. Starting at the PSR, where the second polarization is generated, polarization-dependent losses may be experienced. Various embodiments of suitable polarization rotators and splitters that can be implemented are described in co-pending U.S. provisional patent application Ser. No. 62/118,420 and co-pending U.S. provisional patent application Ser. No. 62/132,742. The combined signal is then provided as output at optical output port 170.

By way of example, let the input signal at input port 120 have a power of 10 dBm. In one embodiment, the directional coupler 130 splits the light 50/50 between the two paths resulting in a 3 dB loss of the power in each arm. If the losses in each of the optical manipulation circuits 140, 150 are 2 dB for the TE mode as illustrated, and the losses in the PSR are 5 dB for one of the two modes TE and TM and only 1 dB for the other mode, then the signals will be attenuated to 7 dBm after the directional coupler 130, and will be attenuated to 5 dBm after the two optical manipulation circuits 140, 150. However, the output signal will have one polarization attenuated by an additional 5 dB, leaving 0 dBm of power for that polarization, and having the other polarization attenuated by 1 dB, leaving 4 dBm of power in that polarization. This results in a power mismatch of 4 dB. If this polarization dependent-loss is known during the design, the directional coupler can be built so that more power is directed into the higher loss circuit such that the power in the two polarizations is equalized at the output of the chip.

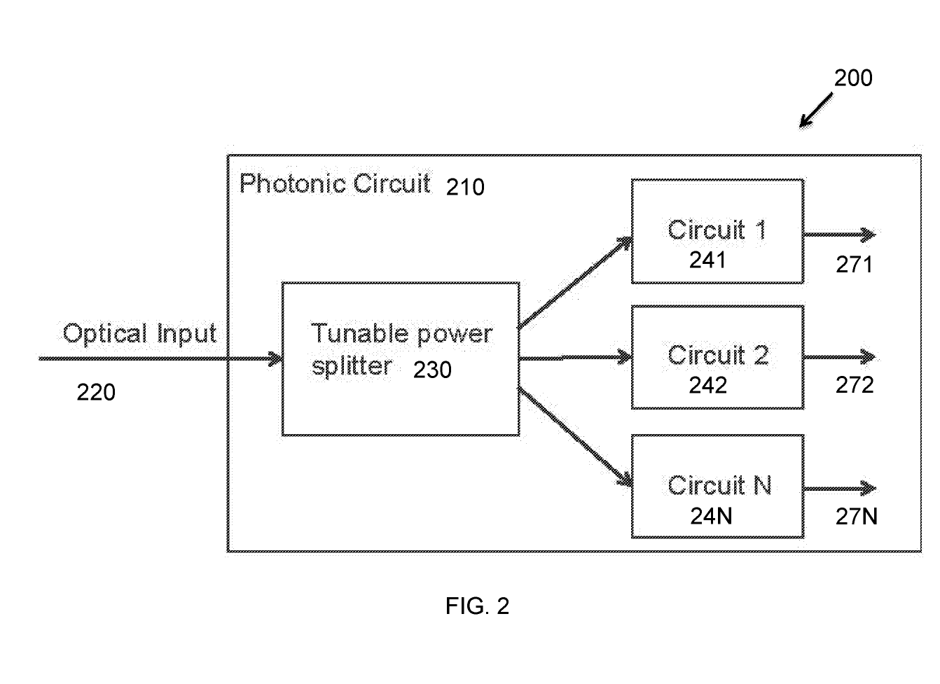

FIG. 2 is a schematic diagram 200 of a photonic circuit 210 that includes a tunable power splitter 230 with N outputs to N separate circuits constructed according to the principles of the invention, where N is an integer greater than one. The tunable power splitter 230 is the subject of the present invention. The tunable power splitter 230 accepts at least one input optical signal at input port 220 having a total power P and splits the at least on input signal into a plurality of signals which can be controlled as to the respective portions of the input optical power P that is each split signal carries. Each split signal is communicated to a circuit (illustrated as circuit 1, 241, circuit 2, 242 and circuit N, 24N). Each circuit provides an output signal, respectively, 271, 272, 27N.

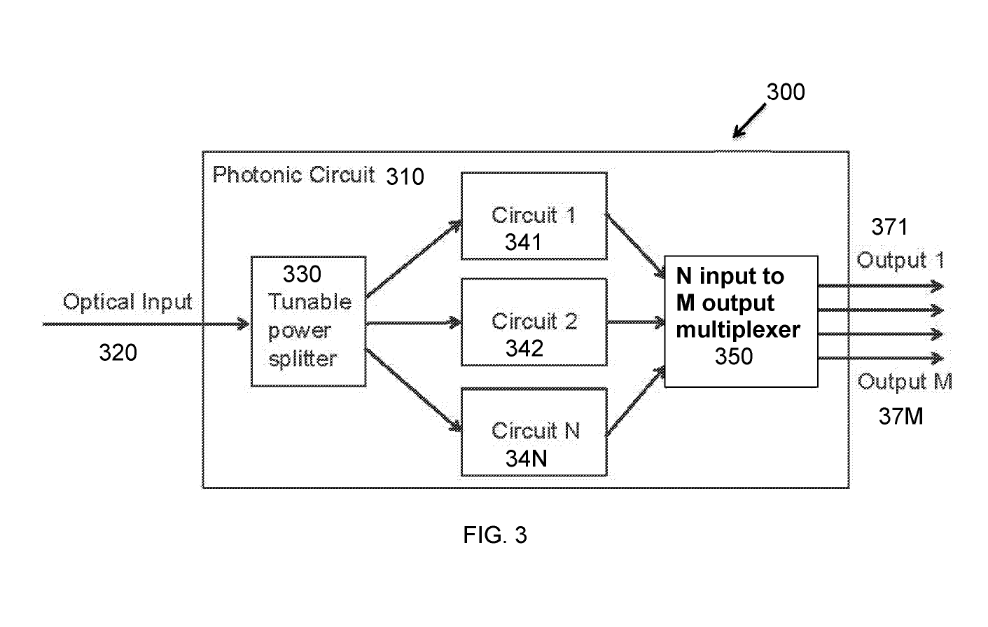

FIG. 3 is a schematic diagram 300 of a photonic circuit 310 that includes a tunable power splitter 330 with N outputs to N separate circuits (341, 342, 34N) and an N input to M output multiplexer 350, where M in an integer. The M outputs are illustrated as 371, . . . 37M). At least some of the polarization and/or wavelength dependent losses in the outputs 371 . . . 37M can be equalized by tuning the tunable power splitter 330.

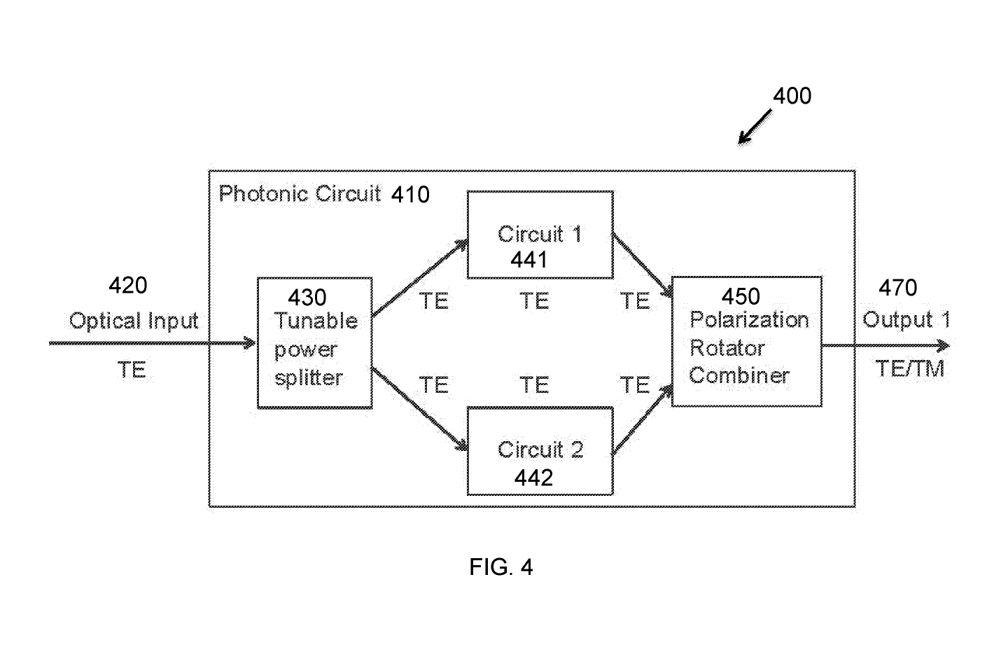

FIG. 4 is a schematic diagram 400 of a photonic circuit including a tunable power splitter 430, two separate circuits 441 and 442 and a polarization rotator combiner 450, constructed according to the principles of the invention. The polarizations at different locations in the photonics circuit are labeled. The embodiment of FIG. 4 is similar to the embodiment of FIG. 1, but includes the ability to provide compensation for losses.

As illustrated in the embodiment shown in FIG. 4, a silicon photonic integrated circuit 410 has an optical input port 420 and an optical output port 470. The optical input port 420 receives optical signals, such as a TE mode optical signal provided by a source. The source can be an optical fiber, a signal generator such as a carrier signal source in conjunction with a modulator, or any other conventional optical signal source. The received signal is split in a tunable power splitter 430 into a plurality signals each characterized by a mode, which are illustrated as two TE modes. However, as compared to the embodiment illustrated in FIG. 1, the tunable power splitter 430 can split the signal into signals having different power levels. For example, rather than two signals each having 10 dB of power as illustrated in FIG. 1, one split signal may have greater power and the other may have lesser power, selected such that the two output signals will have equal power.

One mode is then manipulated by a first optical manipulation circuit 441 to produce a first modified signal and the other mode is then manipulated by a second optical manipulation circuit 442 to produce a second modified signal. The two modified signals are then combined using a combiner circuit 450 (illustrated as a polarization rotator and combiner) which provides an output signal. In the embodiment illustrated in FIG. 4, the polarization of the optical signal is maintained in both optical paths until the combiner circuit 450 generates a second polarization. Because the polarizations from the input port to the PSR are equivalent, there is no polarization dependent loss in in one path over the other path. Starting at the PSR, where the second polarization is generated, polarization-dependent losses may be experienced. Various embodiments of suitable polarization rotators and splitters that can be implemented are described in co-pending U.S. provisional patent application Ser. No. 62/118,420 and co-pending U.S. provisional patent application Ser. No. 62/132,742. The combined signal is then provided as output at optical output port 470.

By way of another example given in relation to FIG. 4, let the input signal at input port 420 have a power of 10 dBm. The tunable power splitter 430 can be tuned to an arbitrary power splitting ratio. The losses in optical manipulation circuits 441, 442 are highly variable. In some instances, they cannot be known before fabrication. In some instances, they are dependent on operational conditions such as temperature. In some instances, both types of uncertainty in the losses that will be encountered can occur. The losses that are likely to be introduced by the polarization rotator combiner 450 are usually well known. The power after the polarization rotator combiner can be monitored and used to tune the tunable power splitter 430, such that the power at the output of the chip 470 is dynamically equalized for the two polarizations in the output signal.

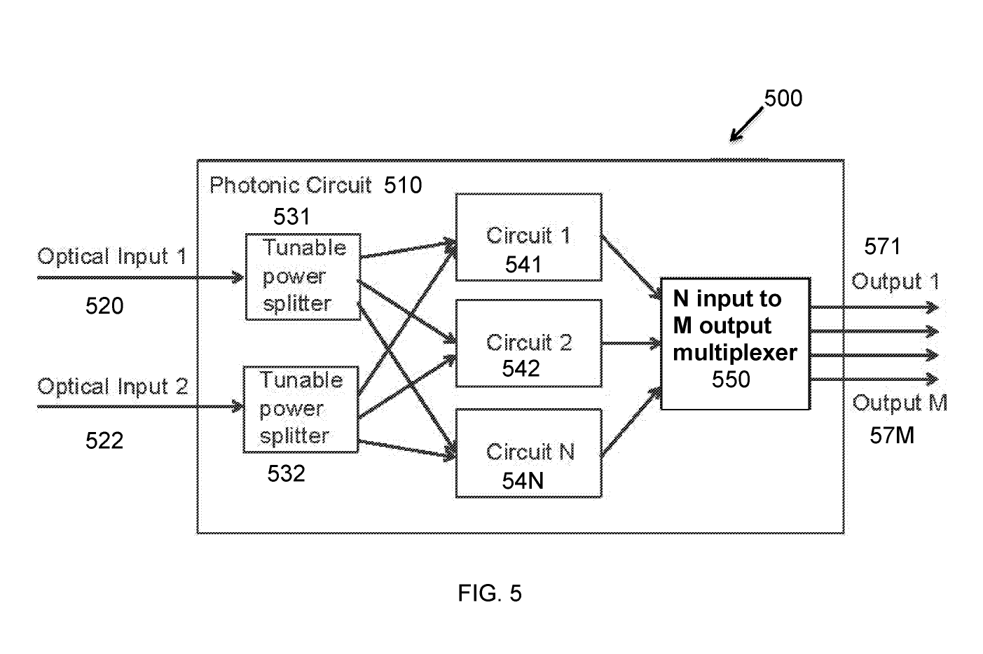

FIG. 5 is a schematic diagram of a photonic circuit that includes two input ports 520, 522, two tunable power splitters 531, 532 each having N outputs to N separate circuits 541, 542, 54N, and an N input to M output multiplexer 550 constructed according to the principles of the invention. The N input to M output multiplexer 550 provides M output signals 571, . . . 57M. At least some of the polarization and/or wavelength dependent losses in the outputs 571 . . . 57M can be equalized by tuning the tunable power splitters 531 and 532.

By way of example given in relation to FIG. 5, let the two input signals at input port 520 and input port 522 be inputs of wavelength 1 and wavelength 2, respectively. Let circuit 1 (541) and circuit 2 (542) be configured to be the operational circuits which exhibit wavelength dependent effects. Let the optical load of circuit 1 (541) be 6 dB for wavelength 1 and 3 dB for wavelength 2. Let the optical load of circuit 2 (542) be 3 dB for wavelength 1 and 6 dB for wavelength 2. The tunable splitters 531 and 532 can then be configured to equalize the output power of wavelength 1 and wavelength 2 from each of circuits 541 and 542 such that the input powers to the N input to M output multiplexer 550 are all equal. Tunable power splitter 531 can be configured to have a coupling ratio of 66/33 while tunable power splitter 532 can be configured to have a coupling ration of 33/66. Circuits 541 and 542 would then have equal output power for each signal and wavelength.

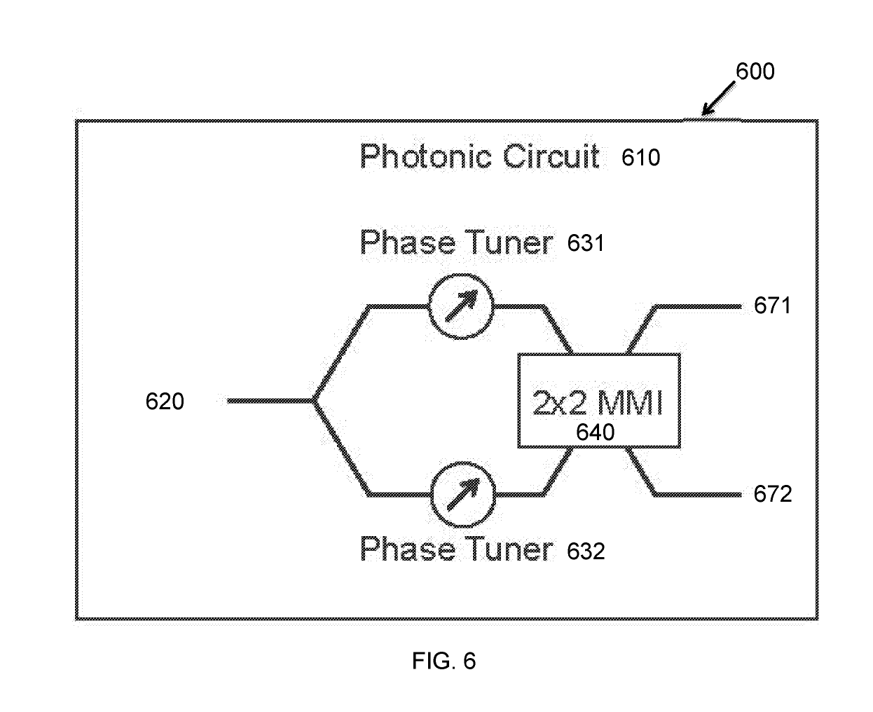

FIG. 6 is a schematic diagram 610 of one implementation of a 1×2 tunable power splitter constructed according to the principles of the invention. The 1×2 tunable power splitter has an input port 620, two optical paths that each include a respective phase tuner 631, 632, and a 2×2 multimode interferometer (MMI) 640. The MMI 640 provides two output signals at output ports 671, 672. The output signals at this stage do not exhibit path-dependent losses. The relative power in the optical output signals can be apportioned by tuning the phase tuners 631, 632.

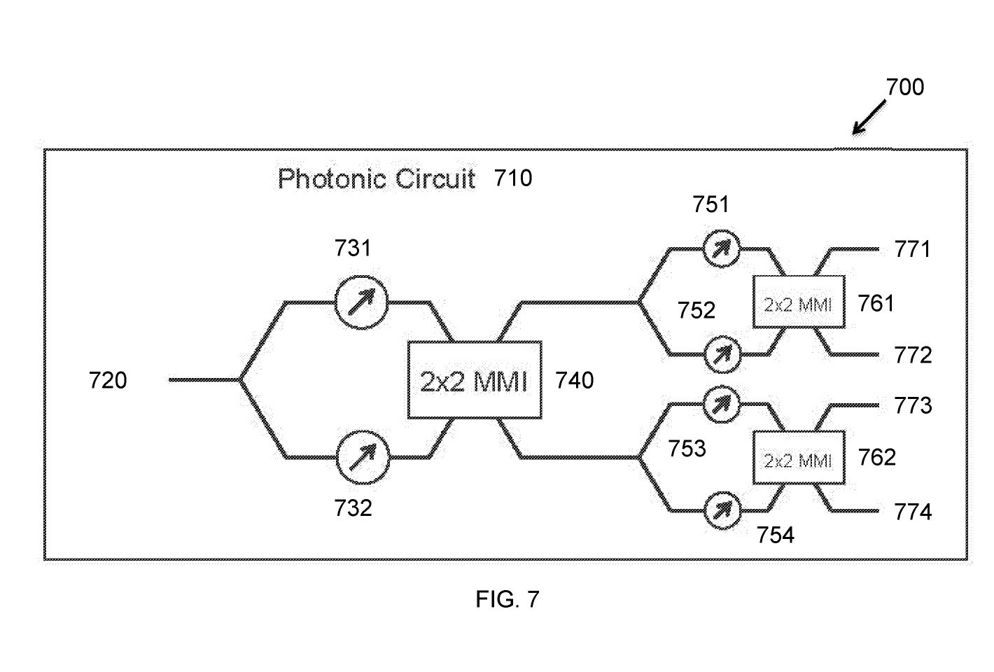

FIG. 7 is a schematic diagram 700 of one implementation of a 1×4 tunable power splitter constructed according to the principles of the invention. The 1×4 tunable power splitter uses two levels of cascaded 1×2 tunable power splitters as illustrated in FIG. 6. The 1×4 tunable power splitter as a single input port 720, two phase tuners 731, 732 and 1 MMI 740 in the first stage of the cascade. The two outputs of the first stage are provided as respective inputs to two additional 1×2 tunable power splitters each having two respective phase tuners (751, 752) (753, 754) which deliver optical power too respective MMIs 761, 762. The four optical outputs 771, 772, 773, 774 can have relative power that is apportioned by tuning any of the phase tuners individually or in combination.

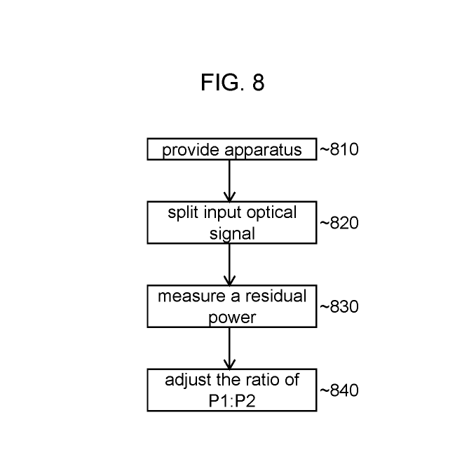

FIG. 8 is a flow diagram that illustrates a method of manipulating an optical signal. As illustrated in FIG. 8, at step 810, recited as “provide apparatus”, one provides an apparatus comprising a variable optical power splitter configured to split an optical input signal having a power P into at least two power components having respective powers represented by a ratio P1:P2, the variable optical power splitter having at least one optical input port configured to receive the optical input signal, and at least one optical output port configured to provide a respective optical output signal, and a respective optical load in optical communication with a selected one of the at least one optical output port, the apparatus configured to compensate for a variation in power that is observable after the optical output signal traverses the respective optical load, the variation in power caused by variations in the optical load.

At step 820, recited as “split an optical signal”, one splits an optical signal having an input power P into at least two power components having respective powers represented by a ratio P1:P2.

At step 830, recited as “measure a residual power”, one measures a residual power Pr1 in the first of the at least two power components after the first power component has traversed a respective optical load.

At step 840, recited as “adjust the ratio of P1:P2”, one adjusts the ratio of P1:P2 based on the measured value of Pr1 and another value. The “another value” can be another measured value, or it can be a value that is stored in a memory, such as an entry in a look-up table. The stored value can be based on previous experience (e.g., measured values), or can be based on theory, or can be based on a desired criterion.

In some embodiments, a feedback loop is used to control the splitting ratio P1:P2 based on one or more measured values, or based on a measured value and another value.

It is believed that apparatus constructed using principles of the invention and methods that operate according to principles of the invention can be used in the wavelength ranges described in Table I.

TABLE I

| Band | Description | Wavelength Range |
|---|---|---|
| O band | original | 1260 to 1360 nm |
| E band | extended | 1360 to 1460 nm |
| S band | short wavelengths | 1460 to 1530 nm |
| C band | conventional (“erbium window”) | 1530 to 1565 nm |
| L band | long wavelengths | 1565 to 1625 nm |
| U band | ultralong wavelengths | 1625 to 1675 nm |

It is believed that in various embodiments, apparatus as previously described herein can be fabricated that are able to operate at a wavelength within the range of a selected one of an O-Band, an E-band, a C-band, an L-Band, an S-Band and a U-band.

It is believed that apparatus constructed using principles of the invention and methods that operate according to principles of the invention can be fabricated using materials systems other than silicon or silicon on insulator. Examples of materials systems that can be used include materials such as compound semiconductors fabricated from elements in Groups III and V of the Periodic Table (e.g., compound semiconductors such as GaAs, AlAs, GaN, GaP, InP, and alloys and doped compositions thereof).

### Design and Fabrication

Methods of designing and fabricating devices having elements similar to those described herein, including high index contrast silicon waveguides, are described in one or more of U.S. Pat. Nos. 7,200,308, 7,339,724, 7,424,192, 7,480,434, 7,643,714, 7,760,970, 7,894,696, 8,031,985, 8,067,724, 8,098,965, 8,203,115, 8,237,102, 8,258,476, 8,270,778, 8,280,211, 8,311,374, 8,340,486, 8,380,016, 8,390,922, 8,798,406, and 8,818,141.

### Definitions

As used herein, the term “optical communication channel” is intended to denote a single optical channel, such as light that can carry information using a specific carrier wavelength in a wavelength division multiplexed (WDM) system.

As used herein, the term “optical carrier” is intended to denote a medium or a structure through which any number of optical signals including WDM signals can propagate, which by way of example can include gases such as air, a void such as a vacuum or extraterrestrial space, and structures such as optical fibers and optical waveguides.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

### Incorporation by Reference

Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. An apparatus, comprising:
a variable optical power splitter configured to split an optical input signal having a power P into at least two power components having respective powers represented by a ratio P1:P2, said variable optical power splitter having at least one optical input port configured to receive said optical input signal, and at least one optical output port configured to provide a respective optical output signal; and
a respective optical load in optical communication with a selected one of said at least one optical output port;
said apparatus configured to compensate for a variation in power that is observable after said optical output signal traverses said respective optical load, said variation in power caused by variations in said optical load.

2. The apparatus of claim 1, wherein said apparatus comprises a multiplexer having N inputs and M outputs, where N and M are integers, at least one of N and M being greater than one.

3. The apparatus of claim 1, wherein said variable optical power splitter is configured to provide multiple signals as output.

4. The apparatus of claim 3, wherein said multiple signals as output comprise multiple polarizations.

5. The apparatus of claim 3, wherein said multiple signals as output comprise multiple wavelengths.

6. The apparatus of claim 1, wherein said variable optical splitter is configured to provide multiple polarizations as output in a single signal.

7. The apparatus of claim 1, wherein said variable optical splitter is configured to provide multiple wavelengths as output in a single signal.

8. The apparatus of claim 1, wherein said optical load is configured to exhibit a loss that depends on an optical path.

9. The apparatus of claim 1, wherein said optical load is configured to exhibit a loss that depends on an optical signal characteristic.

10. The apparatus of claim 1, further comprising a feedback loop comprising a sensor configured to measure at least one power that is observable after a first one of said respective optical output signal traverses said respective optical load and to provide a measurement signal, and a controller configured to receive said measurement signal, configured to compare said measurement signal to another value, and configured to control said ratio P1:P2 by way of at least one control signal input port of said optical power splitter.

11. The apparatus of claim 10, wherein said another value is a measured value of a power that is observable after a different respective optical output signal traverses its respective optical load.

12. The apparatus of claim 10, wherein said another value is a stored value.

13. A method of manipulating an optical signal, comprising the steps of:
providing an apparatus comprising:
a variable optical power splitter configured to split an optical input signal having a power P into at least two power components having respective powers represented by a ratio P1:P2, said variable optical power splitter having at least one optical input port configured to receive said optical input signal, and at least one optical output port configured to provide a respective optical output signal; and
a respective optical load in optical communication with a selected one of said at least one optical output port;
said apparatus configured to compensate for a variation in power that is observable after said optical output signal traverses said respective optical load, said variation in power caused by variations in said optical load;
splitting an optical signal having an input power P into at least two power components having respective powers represented by a ratio P1:P2;
measuring a residual power Pr1 in the first of said at least two power components after said first power component has traversed a respective optical load; and
adjusting the ratio of P1:P2 based on the measured value of Pr1 and another value.

14. The method of manipulating an optical signal of claim 13, wherein said apparatus further comprises a feedback loop comprising a sensor configured to measure at least one power that is observable after a first one of said respective optical output signal traverses said respective optical load and to provide a measurement signal, and a controller configured to receive said measurement signal, configured to compare said measurement signal to another value, and configured to control said ratio P1:P2 by way of at least one control signal input port of said optical power splitter.

15. The method of manipulating an optical signal of claim 13, wherein said another value is a measured value of a power that is observable after a different respective optical output signal traverses its respective optical load.

16. The method of manipulating an optical signal of claim 13, wherein said another value is a stored value.

17. The method of manipulating an optical signal of claim 13, wherein said optical load is configured to exhibit a loss that depends on an optical path.

18. The method of manipulating an optical signal of claim 13, wherein said optical load is configured to exhibit a loss that depends on an optical signal characteristic.
